(19) United States
(12) Patent Application Publication
(10) Pub. No.: US 2005/0024515 A1
(43) Pub. Date: Feb. 3, 2005

(54) Digital camera

(76) Inventors: Tatsuhiko Ikehata, Ome-shi (JP); Tatsuro Abe, Ome-shi (JP); Kei Tashiro, Ome-shi (JP); Tsuyoshi Hagiwara, Ome-shi (JP); Jun Ootsubo, Hamura-shi (JP); Shiro Nagaoka, Ome-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/879,151

(22) Filed: Jun. 30, 2004

(30) Foreign Application Priority Data
Jun. 30, 2003 (JP) 2003-188709

(51) Int. Cl. H04N 5/222

(52) U.S. Cl. 348/333.02

(57) ABSTRACT

A digital camera comprising a display unit, a sound-level detecting unit and a display control unit. The sound-level detecting unit detects a level at which an audio signal is being recorded. The display control unit causes the display unit to display the level detected by the sound-level detecting unit.

### CROSS-REFERENCE TO RELATED APPLICATIONS

This application is based upon and claims the benefit of priority from prior Japanese Patent Application No. 2003-188709, filed Jun. 30, 2003, the entire contents of which are incorporated herein by reference.

### BACKGROUND OF THE INVENTION

1. Field of the Invention

The present invention relates to a digital camera.

2. Description of the Related Art

Most digital cameras have a camera body, a lens exposed outside the camera body, an electronic viewfinder, a display unit, and various switches. The lens is provided on the front of the camera body. As disclosed in, for example, Jpn. Pat. Appln. KOKAI Publication No. 2002-94932, a microphone and a speaker are provided on the camera body.

The digital camera incorporates an imaging element and a recording unit. When the camera takes a moving picture, the imaging element generates image data representing the picture, and the microphone generates audio data. Both the image data and the audio data are recorded in the recording unit. To reproduce the moving picture, the image data and audio data are read and supplied to the display unit and the speaker. The display unit display the moving picture represented by the image data, while the speaker generates the sound represented by the audio data. Namely, the digital camera can take moving pictures and record sounds.

However, the digital camera has no means for informing the user of the volume in which sound is recorded or the volume in which the sound recorded will be reproduced. Therefore, the user cannot know how large the volume is, in which the sound is being or having been recorded.

### BRIEF SUMMARY OF THE INVENTION

According to an aspect of this invention, there is provided a digital camera that comprises a display unit, a sound-level detecting unit and a display control unit. The sound-level detecting unit detects a level at which an audio signal is being recorded. The display control unit causes the display unit to display the level detected by the sound-level detecting unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an example of the table that is displayed on a digital camera according to the invention when the camera is set to an operating mode to photograph a moving picture with sound;

FIG. 2 is a perspective view of a digital camera according to the invention, as viewed from the front;

FIG. 3 is a plan view of the mode dial that is provided on the camera body of the digital camera shown in FIG. 2;

FIG. 4 is a perspective view of the digital camera shown in FIG. 2, as viewed from the back of the camera and somewhat below;

FIG. 5 is a block diagram showing the optical section and electric section of the digital camera shown in FIGS. 2 and 4; and

FIG. 6 is a block diagram illustrating the components that characterizes the optical section and electric section of the digital camera.

### DETAILED DESCRIPTION OF THE INVENTION

A digital camera that is an embodiment of this invention will be described below, with reference to the accompanying drawings.

FIG. 2 is a perspective view of the digital camera according to the invention, as seen from the front. FIG. 4 is another perspective view of the digital camera seen from the back and somewhat below.

As FIG. 2 shows, the digital camera has a shutter button 1001, a mode dial 1002, a power switch 1003, and a front LED 1004, all provided on the camera body 1000. The digital camera further has a flash lamp 1005, a speaker 1006, a microphone 1007, a remote-control receipt unit 1008, a flashlight sensor 1009, and a lens 1010. The remote-control receipt unit 1008 is provided to receive optical signals emitted from a remote controller (not shown).

The digital camera has a flash-open button 1011 and a terminal cover 1012, too. The terminal cover 1012 may be opened to expose an external-microphone terminal, a digital-data terminal, an AV terminal and a DC-input terminal.

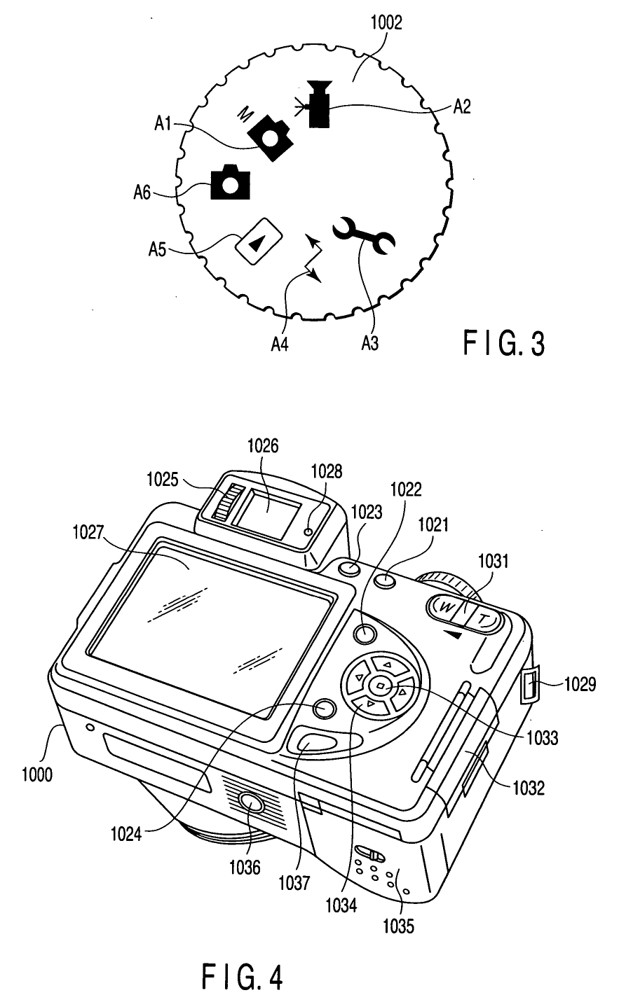

FIG. 3 is a plan view of the mode dial 1002. The mode dial 1002 has icons A1 to A6 printed on it. The icons represent various modes in which the camera can operate. Icon A1 represents the manual-photographing mode (in which the white balance, exposure time, diaphragm opening, shutter speed, and the like can be manually controlled). Icon A2 represents the moving-picture mode (in which a moving picture can be photographed). Icon A3 represents the setup mode (in which the basic setups of the camera, e.g., sound, automatic power-off, customizing, language, image-data output, date and system mode).

Icon A4 represents the PC mode (in which image data is input to personal computers). Icon A5 represents the reproduction mode, and icon A6 represents the automatic photographing mode. The user may turn the mode dial 1002 to bring one of icons A1 to A6 to a specified position, thereby to select the operating mode that the icon represents.

As FIG. 4 shows, a flash button 1021, a menu button 1022, a self-timer & remote-control button 1023, an erase button 1024, and a visibility-adjusting dial 1025 are arranged on the back of the camera. An EVF (electronic viewfinder) 1026 and a liquid crystal display unit 1027 are provided on the back of the camera, too. The liquid crystal display unit 1027 has a screen larger than that of the EVF 1026, which is a liquid crystal display, too. The liquid crystal display unit 1027 will be called “LCD screen” so that it may be distinguished from the EVF.

A finder LED 1028 is arranged besides the EVF 1026; it may emit light to show that the EVF 1026 is on. A shoulder-strap holder 1029 is secured to one side of the camera. Moreover, a Tele/Wide button 1031, an OK button 1033 and selection buttons 1034 are provided on the back of the camera. When operated, the Tele/Wide button 1031 set a degree of zooming. When pushed, each selection buttons 1034 selects a menu items or an image. A card cover 1032 is provided to one side of the camera. A battery cover 1035 is provided on the bottom of the camera. A screw hole 1036 is cut in-the bottom of the camera, to hold the top of a tripod.

A display button 1037 is arranged on the back of the camera. When depressed, the display button 1037 switches the display mode of the EVF 1026 and the LCD screen 1027. If pushed rather long, the display button 1037 sets the EVF 1026 and the LCD screen 1027 in sleep mode to save the battery power. The LCD screen 1027 has a size ranging from 1.5 to 2.5 inches, as most display units of this type. By contrast, the EVF 1026 is a small peeping window.

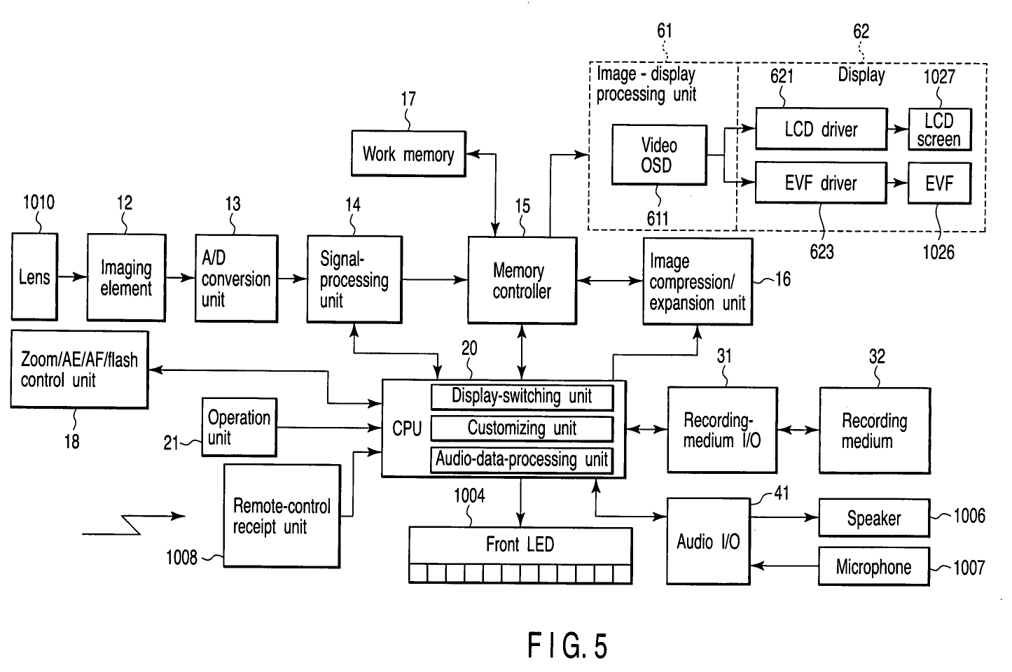

FIG. 5 is a block diagram that illustrates the optical section and electric section of the digital camera. As may be understood from FIG. 5, the light from a subject for photography passes through a lens 1010 and reaches the image-forming surface of an imaging element 12 (e.g., a CCD element), thus forming an image of the subject. The imaging element 12 converts the image into an electric signal. The electric signal is supplied to an analog-to-digital (A/D) conversion unit 13. The unit 13 converts the signal to a digital signal, which is input to a signal-processing unit 14. The signal-processing unit 14 performs gamma correction, color-signal separation, white-balance control, and the like.

Unless the shutter is operated in normal photo-graphing conditions, the signal-processing unit 14 outputs image data via a memory controller 15 to an image-display processing unit 61. The processing unit 61 converts the image data to data that the EVF 1026 or LCD screen 1027 can display and combines menu items or the like data items, thus generating new image data. This image data is supplied from the image-display processing unit 61 to the LCD driver 621 and/or the EVF driver 623, both incorporated in a display 62. Thus, the EVF 1026 or the LCD screen 1027 displays the image being photographed.

When the shutter is operated, an image compression/expansion unit 16 compresses the image data (in JPEG mode, for example). The image data thus compressed is stored via a recording-medium interface 31 into a recording medium 32 under the control of a CPU (Central Processing Unit) 20 serving as control means. The recording medium 32 may be one selected from various media. It may be, for example, a semiconductor memory, an optical disk or a magnetic disk.

The image data may be read from the recording medium 32. In this case, the image compression/expansion unit 16 expands the image data under the control of the CPU 20. The image data thus expanded is input to the image-display processing unit 61 the memory controller 15. Thus, the EVF 1026 or the LCD screen 1027 displays the image represented by the image data.

A work memory 17 is used in the process of editing the image data, forming a thumbnail image or changing the order of images. The work memory 17 can store one frame of image data or frames of image data. The image data stored in the work memory 17 is input, whenever necessary, to the image-display processing unit 61 via the memory controller 15. Thus, the user can know how the image data is being edited, looking at the image displayed by the display 62.

While the image data is being generated or edited, audio data can be acquired (or recorded) from a microphone 1007 via an audio interface 41 under the control of the CPU 20. The audio data is stored, along with the image data, in the recording medium 32. The audio data is read from the recording medium 32, together with the image data. It is then supplied via the audio interface 41 to a speaker 1006. The speaker 1006 generates sound from the audio data, while the image data is being reproduced. The audio interface 41 includes an A/D conversion unit and a D/A conversion unit. The audio interface 41 converts the audio data to digital data. The digital data is recorded in the recording medium 32. The digital audio data can be read from the medium 32 and be converted by the audio interface 41 to analog data, which is supplied to the speaker 1006. The speaker 1006 generates sound from the analog audio data.

The present embodiment is characterized in that the volume in which sound is recorded or the volume in which the sound recorded is reproduced is displayed under the control of the CPU 20. While the audio data is being, for example, recorded under the control of the CPU 20, the volume of the sound is continuously detected. The maximum volume detected during each period is detected as peak level, by means of hardware in this embodiment. Nonetheless, the peak level may be detected by means of software, instead, in the present invention.

In preparation for a photographing operation, the CPU 20 makes a control unit 18 perform zooming, AE (Auto Exposure) adjustment, AF (Auto Focus) adjustment, flash control and the like in accordance with control signals. The CPU 20 receives operation signals from external devices through an operation unit 21 and a remote-control receipt unit 1008. The CPU 20 is connected to an external connection interface (not shown). Hence, the camera can be connected to external displays such as TVs.

The CPU 20 can control the front LED 1004. The front LED 1004 can emit light in different colors, each in various modes, to inform the user, who is standing in front of the camera, of the current operating mode of the camera. More precisely, the front LED 1004 can emit light in different colors, in various combinations of timing, luminance and color.

The user can combine each light-emitting mode with the colors in which the front LED 1004 can emit light. In other words, the user can customize various mode-color combinations.

The digital camera has two display units (i.e., first display unit (EVF) and second display unit (LCD screen)). These displays are automatically switched, from one to the other, in accordance with the mode in which the digital camera is operating.

The CPU 20 has a customizing unit, an audio-data-processing unit, and a display-switching unit. The customizing unit customizes various mode-color combinations. The audio-data-processing unit processes audio data. The display-switching unit switches the two display units. The CPU further has a means for changing the operating mode of each display unit to the previous operating mode. The previous operating mode is, for example, the initial operating mode that is set when the power switch is turned off.

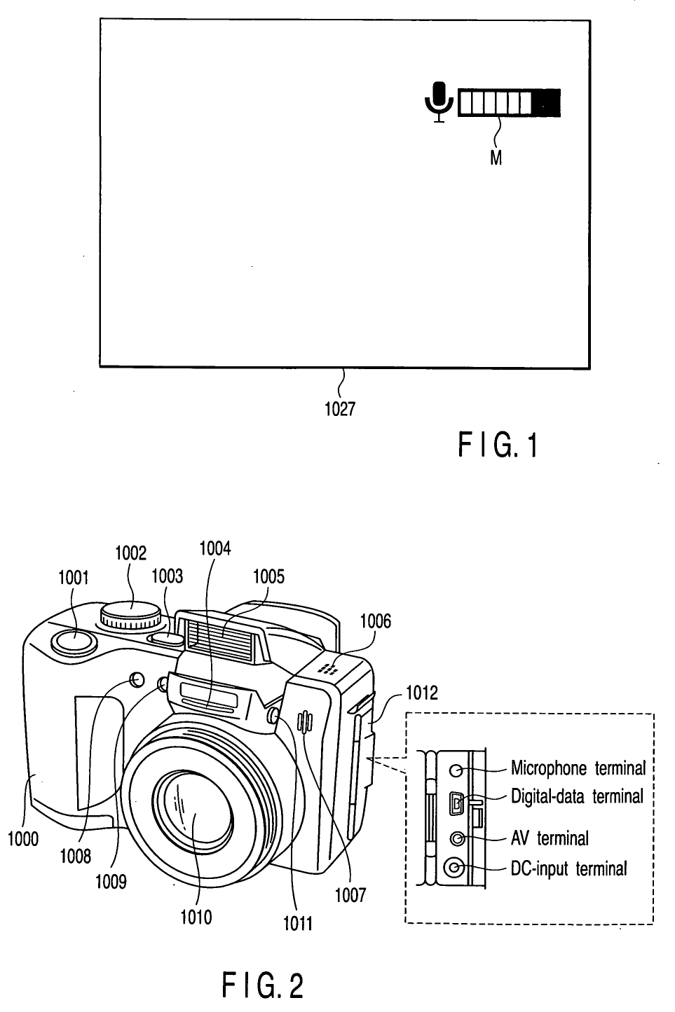

FIG. 1. is a diagram showing an example of the table that is displayed on the digital camera when the camera is set to an operating mode to photograph a moving picture and record sound. The digital camera has means for displaying the volume in which sound is being recorded or the volume in which the sound recorded is being reproduced. Thus, the user can visually perceive the volume of sound that is being recorded or reproduced. The volume is displayed on LCD screen 1027, in the form of a sound-level peak meter M.

The sound-level peak meter M indicates the peak value of the audio data detected by the above-mentioned method. Hence, the peak meter M shows the volume of the sound being recorded or reproduced. The peak meter M is displayed while a moving picture is being reproduced, too. In this case, the sound-level peak meter M may be displayed, even if the speaker 1006 does not reproduce the sound. This achieves a specific advantage as will be described later.

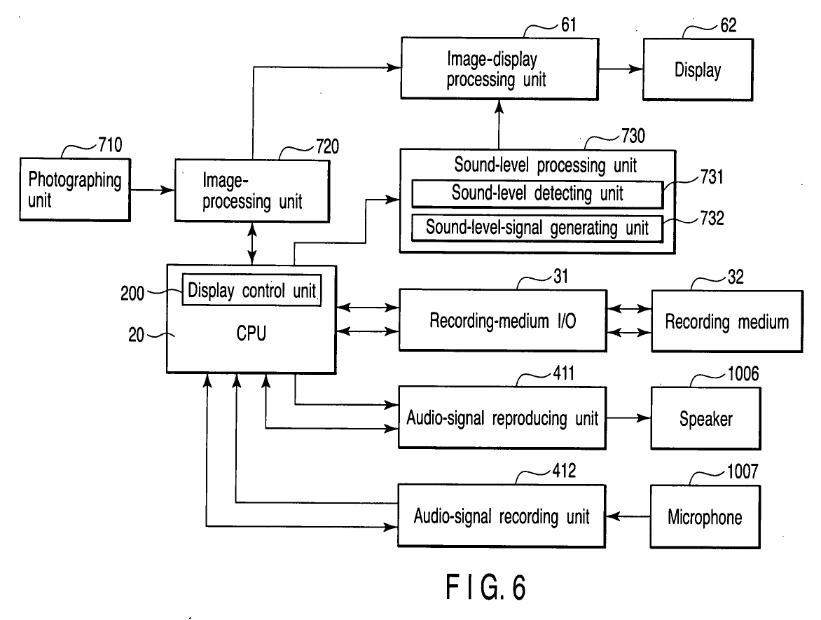

FIG. 6 illustrates the components that characterize the optical section and electric section of the digital camera according to this invention. As FIG. 6 shows, the digital camera has a photographing unit 710, an image-processing unit 720, and a sound-level processing unit 730. The photographing unit 710 includes a lens 1010, the imaging element 12, and the A/D conversion unit 13. The image-processing unit 720 includes the signal-processing unit 14, memory controller 15, image compression/expansion unit 16 and work memory 17.

The digital camera further has an audio-signal reproducing unit 411 and an audio-signal recording unit 412. The microphone 1007 collects sound to be recorded and generates an audio signal. The audio signal is supplied to the audio-signal recording unit 412. The unit 412 processes the audio signal, generating audio data, under the control of the CPU 20. The audio data is recorded in the recording medium 32. To reproduce the audio signal, the audio data is read from the recording medium 32, under the control of the CPU 20. The audio-signal reproducing unit 411 converts the audio data to an audio signal, which is supplied to the speaker 1006. The speaker 1006 generates sound from the audio signal.

The CPU 20 has a display control unit 200 serving as display control means. The sound-level processing unit 730 has a sound-level detecting unit 731 serving as sound-level detecting means and a sound-level-signal generating unit 732. The sound-level detecting unit 731 can detect the level of sound, no matter whether the sound is being recorded or reproduced. The unit 731 outputs sound-level data to the sound-level-signal generating unit 732. The unit 732 generates a sound-level signal from the sound-level data. The sound-level signal is input to the image-display processing unit 61 under the control of the display control unit 200. The unit 61 processes the sound-level signal, generating data. This data, which represents a sound-level peak meter M, is supplied to the display 62. The display 62 displays the sound-level peak meter M as illustrated in FIG. 1. That is, the CPU 20 incorporates the display control unit 200 that causes the LCD screen 1027 to display the data showing the level (or volume) of the sound detected by the microphone 1007. Seeing the peak meter M displayed on the LCD screen 1027, the user can know sound level. This is quite helpful to those who have difficulty in hearing.

The CPU 20 has muting means that can prohibit the audio-signal reproducing unit 411 from supplying the audio signal to the speaker 1006. Thus, the speaker 1006 may generate no sound, while the When the muting means prohibits the unit 411 from supplying the audio signal to the speaker 1006, while the LCD screen 1027 displaying the sound-level peak meter M. The muting means is useful when the user takes a moving picture of a person who is delivering a speech at a wedding or a person who is lecturing in an auditorium.

The audio data can be displayed in the form of a peak meter M, while the camera is taking a moving picture or reproducing the moving picture. The user of the camera can know the volume in which the sound is being recorded. If the user finds the volume is too small or too large, he or she may adjust the volume to a desired value. This prevents errors in recording the sound.

As mentioned above, the peak meter M is useful when the user records audio data. It is particularly useful when an externally supplied audio signal is supplied to the digital-data terminal or the DC-input terminal or when a microphone with directivity is connected to the external-microphone terminal to collect sound.

Seeing the sound-level peak meter M displayed on the LCD screen 1027, the user can recognize the volume in which sound is being recorded. This means that the user can grasp the volume, even if the speaker 1006 is muted. Thus, the peak meter M is very useful in determining whether the sound is recorded as desired, in places where it should be quiet.

The present invention is not limited to the embodiment described above. Various changes and modifications can be made within the scope and spirit of the invention. The level at which an audio signal is being recorded or reproduced may be displayed on the EVF 1026, not on the LCD screen 1027 as described above. Further, the sound-level detecting unit 731 may only need to detect the level of the audio signal being recorded or that of the audio signal being reproduced, or both.

1. A digital camera comprising:
a display unit;
a sound-level detecting unit which detects a level at which an audio signal is being recorded; and
a display control unit which causes the display unit to display the level detected by the sound-level detecting unit.

2. A digital camera comprising:
a display unit;
a sound-level detecting unit which detects a level at which an audio signal is being reproduced; and
a display control unit which causes the display unit to display the level detected by the sound-level detecting unit.

3. A digital camera comprising:
a display unit;
a sound-level detecting unit which detects a level at which an audio signal is being recorded and a level at which the audio signal is being reproduced; and
a display control unit which causes the display unit to display the levels detected by the sound-level detecting unit.

4. The digital camera according to claim 1, further comprising an image-processing unit which generates image data,
wherein the display unit has an electronic viewfinder which displays an image represented by the image data supplied from the image-processing unit.

5. The digital camera according to claim 2, further comprising an image-processing unit which generates image data,
wherein the display unit has an electronic viewfinder which displays an image represented by the image data supplied from the image-processing unit.

6. The digital camera according to claim 3, further comprising an image-processing unit which generates image data,
wherein the display unit has an electronic viewfinder which displays an image represented by the image data supplied from the image-processing unit.

7. The digital camera according to claim 1, further comprising an image-processing unit which generates image data,
wherein the display unit has a liquid crystal display which displays an image represented by the image data supplied from the image-processing unit.

8. The digital camera according to claim 2, further comprising an image-processing unit which generates image data,
wherein the display unit has a liquid crystal display which displays an image represented by the image data supplied from the image-processing unit.

9. The digital camera according to claim 3, further comprising an image-processing unit which generates image data,
wherein the display unit has a liquid crystal display which displays an image represented by the image data supplied from the image-processing unit.

10. The digital camera according to claim 1, further comprising a speaker, and a control unit which mutes the speaker even if data representing the level detected by the sound-level detecting unit is output to the display unit.

11. The digital camera according to claim 2, further comprising a speaker, and a control unit which mutes the speaker even if data representing the level detected by the sound-level detecting unit is output to the display unit.

12. The digital camera according to claim 3, further comprising a speaker, and a control unit which mutes the speaker even if data representing the level detected by the sound-level detecting unit is output to the display unit.

13. A digital camera comprising:
a display unit;
a sound-level detecting means for detecting a level at which an audio signal is being recorded; and
a display control means for causing the display unit to display the level detected by the sound-level detecting means.
